(19) United States
(12) Patent Application Publication
(10) Pub. No.: US 2017/0047088 A1
(43) Pub. Date: Feb. 16, 2017

(54) NEAR-FIELD TRANSDUCER FOR HEAT ASSISTED MAGNETIC RECORDING WITH TRAILING EDGE TAPER AND SIDE TAPER

(71) Applicant: HGST Netherlands B.V., Amsterdam (NL)

(72) Inventors: Takuya MATSUMOTO, Sunnyvale, CA (US); Barry C. STIPE, San Jose, CA (US)

(73) Assignee: HGST Netherlands B.V.

(21) Appl. No.: 14/826,023

(22) Filed: Aug. 13, 2015

(51) Int. Cl. G11B 5/48

(52) U.S. Cl. CPC G11B 5/4866; G11B 2005/0021

(57) ABSTRACT

Embodiments disclosed herein generally relate to a HAMR head. The HAMR head includes a main pole, a waveguide and a NFT disposed between the main pole and the waveguide. The NFT includes an antenna, and a portion of the antenna is disposed at a media facing surface. By increasing the volume of the antenna extending from the MFS, the temperature of the NFT during operation is reduced.

### BACKGROUND

Field

Embodiments disclosed herein generally relate to a magnetic disk device employing a heat assisted magnetic recording (HAMR) head.

Description of the Related Art

In a magnetic disk device that employs a HAMR head, a near-field transducer (NFT) may be utilized to locally heat magnetic media having high coercivity during recording to lower the coercivity of the localized region. Gold is typically used for the NFT material to achieve a high optical efficiency, but the melting point of gold is low and deformation of the NFT is a problem when the NFT is heated for a long term. The NFT temperature is especially high near the point where the optical near-field is generated, and the maximum temperature reaches more than 150 degrees Celsius over the operational temperature of the magnetic disk device. When the NFT temperature is more than 150 degrees Celsius over the operational temperature of the magnetic disk device, atomic diffusion of gold atoms via surface, grain boundary, or lattice increases significantly, causing the NFT to deform.

Therefore, there is a need in the art for an improved HAMR head.

### SUMMARY

Embodiments disclosed herein generally relate to a HAMR head. The HAMR head includes a main pole, a waveguide and a NFT disposed between the main pole and the waveguide. The NFT includes an antenna, and a portion of the antenna is disposed at a media facing surface (MFS). By increasing the volume of the antenna extending from the MFS, the temperature of the NFT during operation is reduced.

In one embodiment, a HAMR head includes a main pole, a waveguide, and a NFT disposed between the main pole and the waveguide. The NFT includes an antenna, and the antenna includes a first surface facing the main pole. The first surface is angled with respect to an axis perpendicular to a MFS.

In another embodiment, a HAMR head includes a main pole, a waveguide, and a NFT disposed between the main pole and the waveguide. The NFT includes an antenna and the antenna includes a first surface facing the main pole. The first surface has a first side at a media facing surface, a second side opposite the first side, a third side connecting the first and second sides, and a fourth side opposite the third side, and wherein at least one of the third and fourth sides is angled with respect to an axis perpendicular to the media facing surface.

In another embodiment, a hard disk drive includes a magnetic media, a magnetic read head, and a HAMR magnetic write head. The HAMR magnetic write head includes a main pole, a waveguide, and a NFT disposed between the main pole and the waveguide. The NFT includes an antenna, and the antenna includes a surface facing the main pole. The surface is angled with respect to an axis perpendicular to a MFS.

### BRIEF DESCRIPTION OF THE DRAWINGS

So that the manner in which the above recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments in any field involving magnetic sensors.

FIGS. 1A and 1B illustrate a disk drive system according to embodiments described herein.

FIGS. 2A and 2B illustrate a HAMR write head according to one embodiment described herein.

FIGS. 3A-3C illustrate the HAMR write head according to various embodiments described herein.

FIGS. 4A and 4B illustrate the HAMR write head according to various embodiments described herein.

FIGS. 5A-5C are fragmented cross sectional side views of the HAMR write head according to various embodiments described herein.

FIGS. 6A-6C are fragmented cross sectional side views of the HAMR write head according to various embodiments described herein.

FIGS. 7A-7C illustrate the HAMR write head according to various embodiments described herein.

FIG. 7D is a chart showing relationships between NFT temperature rise and a location of a flare point and between laser power and the location of the flare point according to various embodiments described herein.

FIGS. 8A-8B illustrate the HAMR write head according to various embodiments described herein.

FIG. 8C is a chart showing the effect of an angle on a normalized efficiency of the HAMR write head according to various embodiments described herein.

FIGS. 9A-9B illustrate an antenna prior to forming a media facing surface according to various embodiments described herein.

FIG. 9C is a chart showing an effect of a position of the media facing surface on NFT temperature change and on laser power according to various embodiments described herein.

FIG. 10A illustrates the HAMR write head according to various embodiments described herein.

FIG. 10B is a chart showing an effect of having side taper on NFT temperature and cross-track gradient.

FIG. 11A illustrates the HAMR write head according to various embodiments described herein.

FIG. 11B is a chart showing an effect of having inclined surface, side taper, and the combination of the two on NFT temperature rise.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments. However, it should be understood that the disclosure is not limited to specific described embodiments. Instead, any combination of the following features and elements, whether related to different embodiments or not, is contemplated to implement and practice the claimed subject matter. Furthermore, although embodiments described herein may achieve advantages over other possible solutions and/or over the prior art, whether or not a particular advantage is achieved by a given embodiment is not limiting of the claimed subject matter. Thus, the following aspects, features, embodiments and advantages are merely illustrative and are not considered elements or limitations of the appended claims except where explicitly recited in a claim(s).

Embodiments disclosed herein generally relate to a HAMR head. The HAMR head includes a main pole, a waveguide and a NFT disposed between the main pole and the waveguide. The NFT includes an antenna, and a portion of the antenna is disposed at a MFS. By increasing the volume of the antenna extending from the MFS, the temperature of the NFT during operation is reduced.

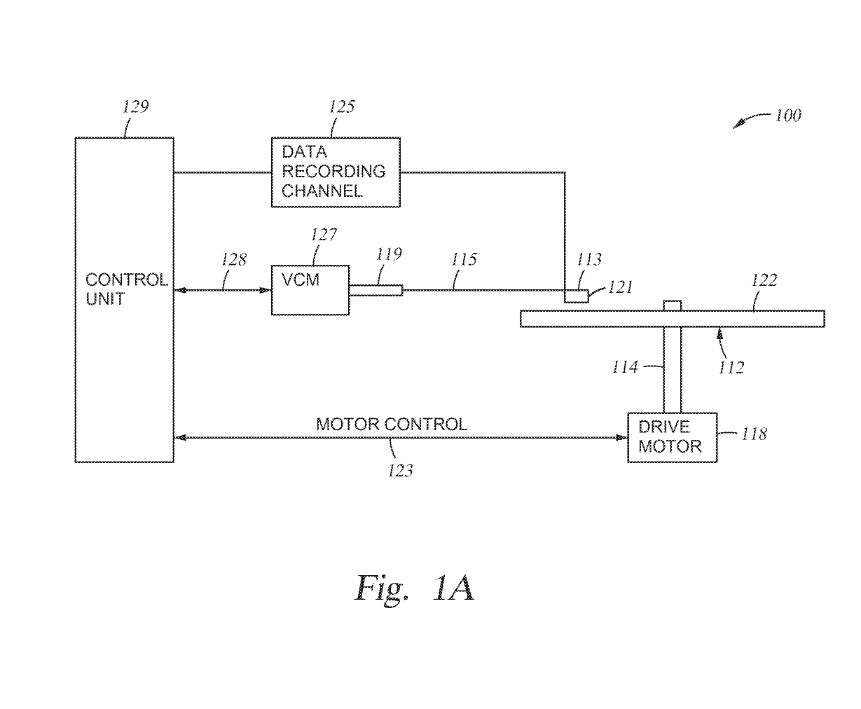

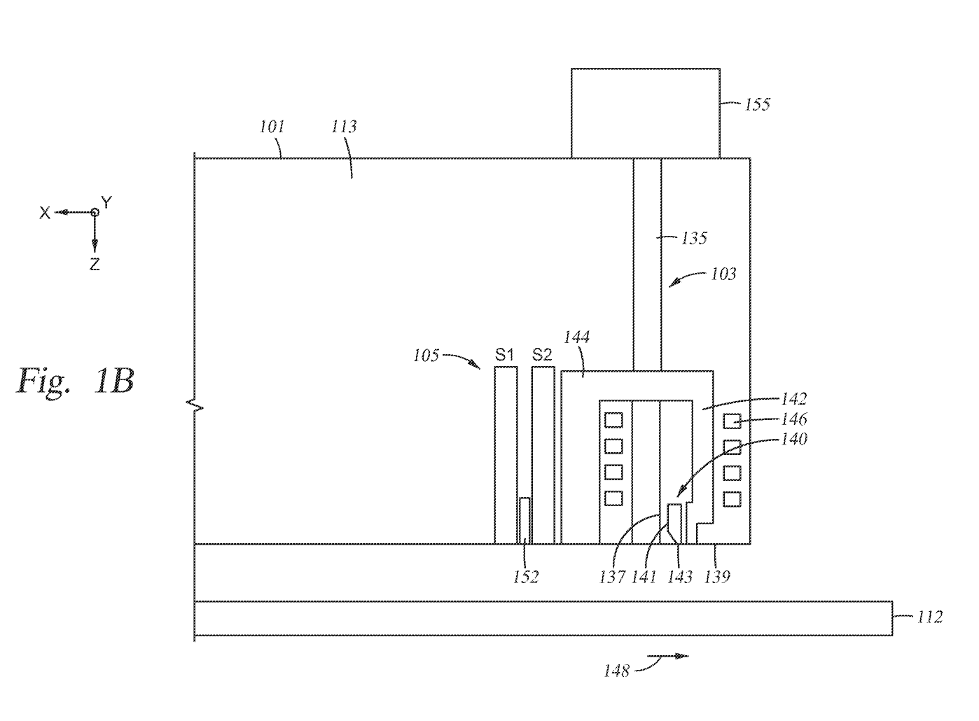

FIG. 1A illustrates a disk drive 100 embodying this disclosure. As shown, at least one rotatable magnetic media 112 is supported on a spindle 114 and rotated by a disk drive motor 118. The magnetic recording on each media is in the form of any suitable patterns of data tracks, such as annular patterns of concentric data tracks (not shown) on the magnetic media 112.

At least one slider 113 is positioned near the magnetic media 112, each slider 113 supporting one or more magnetic head assemblies 121 that may include a radiation source (e.g., a laser or LED) for heating the media surface 122. As the magnetic media 112 rotates, the slider 113 moves radially in and out over the media surface 122 so that the magnetic head assembly 121 may access different tracks of the magnetic media 112 to read or record data. Each slider 113 is attached to an actuator arm 119 by way of a suspension 115. The suspension 115 provides a slight spring force which biases the slider 113 toward the media surface 122. Each actuator arm 119 is attached to an actuator means 127. The actuator means 127 as shown in FIG. 1A may be a voice coil motor (VCM). The VCM includes a coil movable within a fixed magnetic field, the direction and speed of the coil movements being controlled by the motor current signals supplied by control unit 129.

During operation of a HAMR enabled disk drive 100, the rotation of the magnetic media 112 generates an air bearing between the slider 113 and the media surface 122 which exerts an upward force or lift on the slider 113. The air bearing thus counter-balances the slight spring force of suspension 115 and supports slider 113 slightly above the media 112 surface by a small, substantially constant spacing during normal operation. The radiation source heats up the high-coercivity media so that the write elements of the magnetic head assembly 121 may correctly magnetize the data bits in the media.

The various components of the disk drive 100 are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on media 112. Write and read signals are communicated to and from write and read heads on the assembly 121 by way of recording channel 125.

The above description of a typical magnetic disk storage system and the accompanying illustration of FIG. 1A are for representation purposes only. It should be apparent that disk storage systems may contain a large number of media and actuators, and each actuator may support a number of sliders.

FIG. 1B is a fragmented, cross sectional side view of a HAMR read/write head 101 and magnetic media 112 of the disk drive 100 of FIG. 1. The read/write head 101 may correspond to the magnetic head assembly 121 described in FIG. 1. The read/write head 101 includes a MFS 139, such as an air bearing surface (ABS), a write head 103 and a magnetic read head 105, and is mounted on the slider 113 such that the MFS 139 is facing the magnetic media 112. As shown in FIG. 1B, the magnetic media 112 moves past the write head 103 in the direction indicated by the arrow 148. As shown in FIG. 1B and subsequent figures, the X direction denotes an along-the-track direction, the Y direction denotes a track width or cross-track direction, and the Z direction denotes a direction substantially perpendicular to the MFS 139.

In some embodiments, the magnetic read head 105 is a magnetoresistive (MR) read head that includes an MR sensing element 152 located between MR shields S1 and S2. In other embodiments, the magnetic read head 105 is a magnetic tunnel junction (MTJ) read head that includes a MTJ sensing element 152 located between MR shields S1 and S2. The magnetic fields of the adjacent magnetized regions in the magnetic media 112 are detectable by the MR (or MTJ) sensing element 152 as the recorded bits.

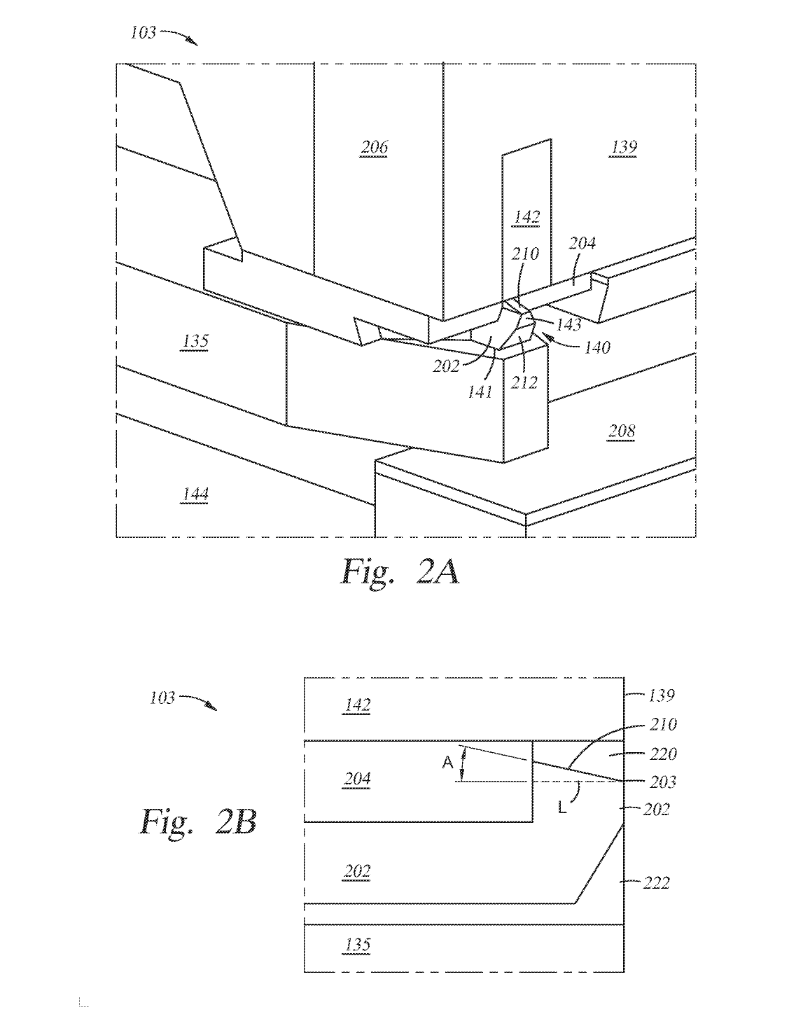

The write head 103 includes a main pole 142, a waveguide 135, a NFT 140 disposed between the main pole 142 and the waveguide 135, a return pole 144, and a coil 146 that excites the main pole 142. A spot size converter (not shown) may be coupled to the NFT 140 and may be substantially parallel to the waveguide 135. The write head 103 may be operatively attached to a laser 155 (i.e., a radiation source). The laser 155 may be placed directly on the write head 103 or radiation may be delivered from the laser 155 located separate from the slider 113 through an optical fiber or waveguide. The waveguide 135 is a channel that transmits the radiation through the height of the write head 103 to the NFT 140—e.g., a plasmonic device or optical transducer—which is located at or near the MFS 139. When radiation, such as a laser beam, is introduced into the waveguide 135, an evanescent wave is generated at a surface 137 of the waveguide 135 that couples to a surface plasmon excited on a surface 141 of the NFT 140. The surface plasmon propagates to a surface 143 of the NFT 140, and an optical near-field spot is generated near an apex (see FIG. 2B) of the surface 143. In other embodiments, the waveguide 135 may not extend to the MFS 139, and the NFT 140 may be disposed at an end of the waveguide 135, so the NFT 140 is aligned with the waveguide 135. The embodiments herein, however, are not limited to any particular type of radiation source or technique for transferring the energy emitted from the radiation source to the MFS 139. The NFT 140 as shown in FIG. 1B is a nanobeak NFT. However, the NFT 140 is not limited to any particular type of NFT. In some embodiments, the NFT 140 is an e-antenna NFT or a lollipop NFT.

FIG. 2A is a fragmented perspective view of the HAMR write head 103, according to one embodiment described herein. To better illustrate certain components of the write head 103, a cladding material and a spacer layer are omitted. The write head 103 includes the NFT 140, and the NFT 140 may include an antenna 202. The write head 103 may further include a thermal shunt 204 coupled to the antenna 202. The thermal shunt 204 may be made of a conductive material. The write head 103 may further include a heat sink 206 surrounding the main pole 142 and a mirror layer 208 disposed on a surface of the return pole 144. The thermal shunt 204 may be disposed between the antenna 202 and the heat sink 206. The antenna 202 may include the surface 143 at the MFS 139, the surface 141 facing the waveguide 135, a surface 210 facing the main pole 142, and a surface 212 connecting the surface 143 and the surface 141. The surface 141 may be substantially perpendicular to the MFS 139. The antenna 202 may be made of a conductive metal, such as gold (Au), silver (Ag), copper (Cu) or aluminum (Al).

FIG. 2B is a fragmented cross sectional view of the HAMR write head 103, according to one embodiment described herein. The write head 103 may include a cladding material 222 disposed between the waveguide 135 and the antenna 202, and the NFT 140 may include a spacer layer 220 disposed between the antenna 202 and the main pole 142. Both the cladding material 222 and the spacer layer 220 may be made of a dielectric material such as alumina, silicon oxide, silicon nitride, silicon oxynitride, or combinations thereof. When light is introduced into the antenna 202 during operation, charges in the antenna 202 are concentrated at an apex 203, which is located at the MFS 139. The large amount of heat generated at the apex 203 causes the temperature of the antenna 202, or the NFT 140, to increase, which may lead to deformation of the antenna 202. The volume of the antenna 202 may be increased in order to increase the heat transfer from the apex 203 to the thermal shunt 204 and the heat sink 206. In one embodiment, as shown in FIG. 2B, the surface 210 is angled, or inclined, with respect to an axis L that is substantially perpendicular to the MFS 139. The apex 203 may be disposed on the axis L. An angle A may be formed between the surface 210 and the axis L, and the angle A may be greater than 0 degrees and less than 90 degrees. Large angle A may decrease the down-track thermal-gradient in the magnetic media 112. In some embodiments, the angle A is less than 30 degrees, such as between about 10 degrees and about 20 degrees, in order to control the reduction in the down-track thermal-gradient to be less than ten percent.

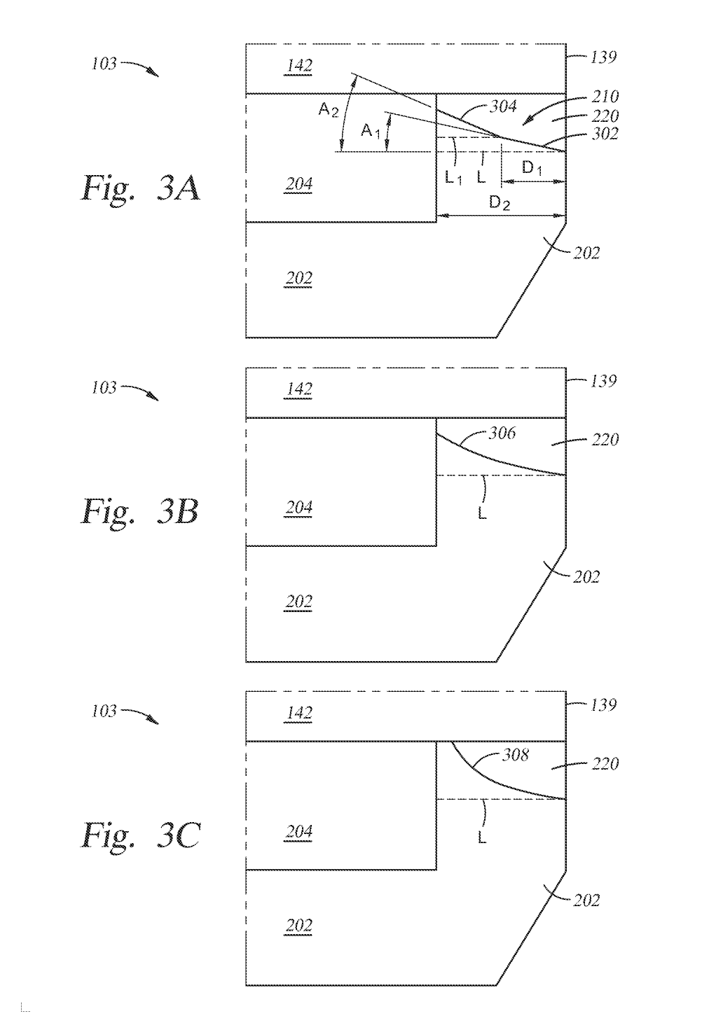

FIGS. 3A-3C illustrate the HAMR write head 103 according to various embodiments described herein. FIG. 3A is a fragmented cross sectional view of the HAMR write head 103, according to one embodiment described herein. As shown in FIG. 3A, the surface 210 may be non-planar, such as including two planar surfaces 302, 304. The surface 302 and the axis L may form an angle A₁, which may be the same as the angle A shown in FIG. 2B. The surface 302 may extend from the MFS 139 to a location that is a distance D₁ away from the MFS 139. In one embodiment, the angle A₁ is about 15 degrees and the distance D₁ is about 20 nm. The surface 304 may extend from the surface 302 to a location that is a distance D₂ away from the MFS 139, and the surface 304 may form an angle A₂ with an axis L₁ that is substantially perpendicular to the MFS 139. The angle A₂ may be greater than 0 and greater than or less than the angle A₁. The surface 304 may contact the thermal shunt 204. In one embodiment, the angle A₂ is about 30 degrees and the distance D₂ is about 80 nm. In some embodiments, the angle A₁ may be 0 degrees and the angle A₂ may be greater than 0 degrees in order to improve the thermal-gradient in the magnetic media 112.

FIG. 3B is a fragmented cross sectional view of the HAMR write head 103, according to one embodiment described herein. As shown in FIG. 3B, a curved surface 306 may be facing the main pole 142. The curved surface 306 may be concave, such that an angle between the curved surface 306 and the axis L increases when moving away from the MFS 139, as shown in FIG. 3B. Alternatively, the curved surface 306 may be convex, such that the angle between the curved surface 306 and the axis L decreases when moving away from the MFS 139. As shown in FIG. 3B, the surface 306 may contact the thermal shunt 204, but might not contact the main pole 142 and the heat sink 206 (shown in FIG. 2A).

FIG. 3C is a fragmented cross sectional view of the HAMR write head 103, according to one embodiment described herein. As shown in FIG. 3C, a curved surface 308 may be facing the main pole 142. The curved surface 308 may be concave, such that an angle between the curved surface 308 and the axis L increases when moving away from the MFS 139, as shown in FIG. 3C. Alternatively, the curved surface 308 may be convex, such that the angle between the curved surface 308 and the axis L decreases when moving away from the MFS 139. Unlike the curved surface 306, the curved surface 308 may be in contact with the main pole 142 and the heat sink 206 (shown in FIG. 2A), and the heat generated in the apex 203 may be transferred directly to the main pole 142 or the heat sink 206.

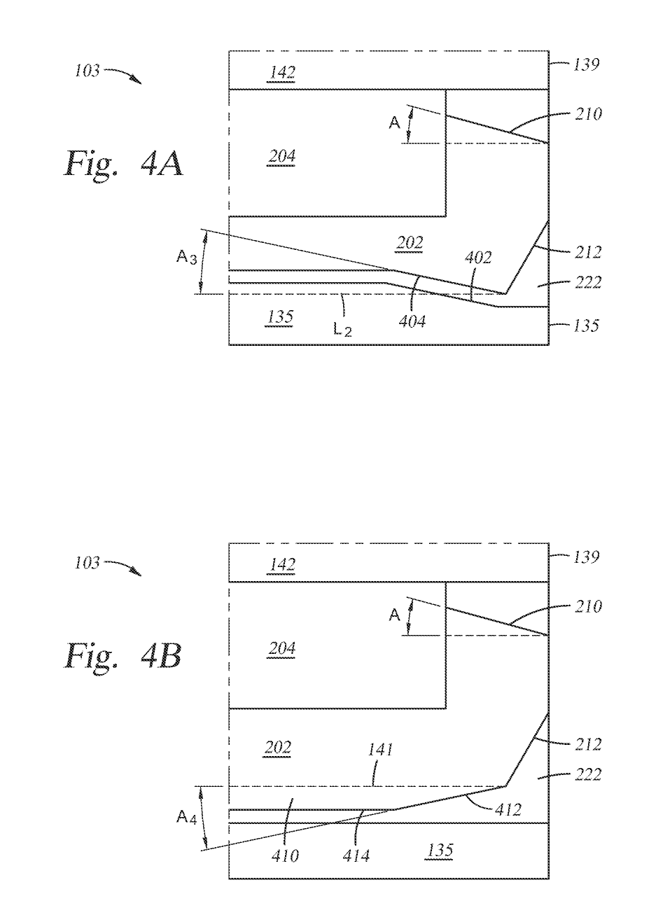

FIGS. 4A and 4B illustrate the HAMR write head 103 according to various embodiments described herein. FIG. 4A is a fragmented cross sectional view of the HAMR write head 103, according to one embodiment described herein. As shown in FIG. 4A, a portion of the waveguide 135 may be etched at an angle in order to form a tapered surface 402. The cladding material 222 may be formed on the waveguide 135, and the antenna 202 may be formed on the cladding material 222. The antenna 202 may include a surface 404 facing the surface 402 of the waveguide 135. The surface 404 of the antenna 202 may be substantially parallel to the surface 402 of the waveguide 135. The surface 404 may form an angle A₃ with an axis L₂ that is substantially perpendicular to the MFS 139. Since the antenna 202 is conformally deposited on the cladding material 222, the surface 210 forms the angle A with the axis L without additional process steps, and the angle A is the same as the angle A₃.

FIG. 4B is a fragmented cross sectional view of the HAMR write head 103, according to one embodiment described herein. As shown in FIG. 4B, an additional portion 410 may be added to the antenna 202 in order to reduce the temperature of the antenna 202 during operation. The additional portion 410 may be added to the surface 141, which is shown using dotted lines since the surface 141 no longer exists in this embodiment. The additional portion 410 may include a surface 414 facing the waveguide 135 and a surface 412 connecting the surface 414 and the surface 212. The surface 414 may be substantially perpendicular to the MFS 139, and the surface 412 may form an angle A₄ with the surface 141. The angle A₄ may be the same as the angle A shown in FIG. 2B. The antenna 202 may also include the surface 210, as shown in FIG. 4B. Alternatively, the antenna 202 may also include surfaces 302, 304, as shown in FIG. 3A, the surface 306, as shown in FIG. 3B, or the surface 308, as shown in FIG. 3C.

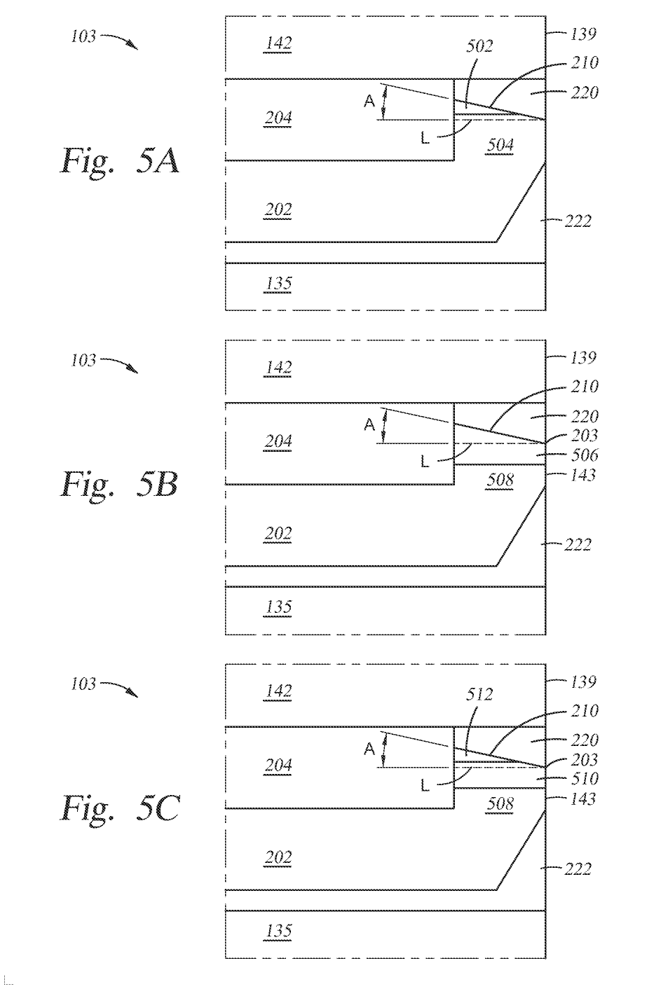

FIGS. 5A-5C are fragmented cross sectional side views of the HAMR write head 103 according to various embodiments. As shown in FIG. 5A, the antenna 202 may include a first portion 502 and a second portion 504. The second portion 504 may be made of a conductive metal, such as Au, Ag, Cu, or Al, and the first portion 502 may be made of a conductive metal that has higher thermal conductivity than the material of the second portion 504. In one embodiment, the second portion 504 is made of Au and the first portion 502 is made of Ag. The first portion 502, when made of Ag, may include a portion of the surface 210 (i.e., the first portion 502 does not extend to the MFS 139) because Ag may be corroded at the MFS 139. In some embodiments, the first portion 502 is made of a conductive metal other than Ag, and the first portion 502 may include the entire surface 210. Again the surface 210 forms the angle A with the axis L.

In some embodiments, the antenna 202 may include a thermally stable material, such as an alloy, at the apex 203. As shown in FIG. 5B, the antenna 202 includes a first portion 506 and a second portion 508. The first portion 506 may include a portion of the surface 143, the apex 203, and the surface 210. The second portion 508 may be made of a conductive metal, such as Au, Ag, Cu, or Al, and the first portion 506 may be made of an alloy, such as a gold alloy, that has higher melting point than the material of the second portion 508. The alloy of the first portion 506 may include one or more metals, such as Rh, Co, Ni, Pt, Pd, Ru, B, Mo, W, Ti, Ir, Re, Au, Ag, Cu, or Al. Examples of the alloy of the first portion 506 include AuRh, AuCo, AuTi, and AuNi. Because the alloy has a higher melting point that the second portion 508, the first portion 506 is more thermally stable than the second portion 508. By using the thermally stable material at the apex 203, which experiences the highest temperature during operation, deformation of the antenna 202 can be prevented. The additional alloy of the first portion 506 including the surface 210 extending from the apex 203 is still more thermally conductive than the dielectric material of the spacer layer 220, thus the temperature of the antenna 202 during operation is reduced. Again the surface 210 forms the angle A with the axis L.

In some embodiments, in order to further reduce the temperature of the antenna 202 during operation, the first portion 506 may be divided into two portions, one made of the thermally stable material and the other made of a material that is more thermally conductive than the thermally stable material. As shown in FIG. 5C, the antenna 202 includes a first portion 510, the second portion 508, and a third portion 512. The first portion 510 may include a portion of the surface 143 and the apex 203, and may be made of an alloy, such as a gold alloy, that has higher melting point than the material of the second portion 508. The alloy of the first portion 510 may include one or more metals, such as Rh, Co, Ni, Pt, Pd, Ru, B, Mo, W, Ti, Ir, Re, Au, Ag, Cu, or Al. The third portion 512 may include at least a portion of the surface 210 and may be made of a conductive metal that is more thermally conductive than the material of the first portion 510. In some embodiments, the third portion 512 is made of the same material as the second portion 508. In other embodiments, the third portion 512 is made of a different material than the second portion 508. In one embodiment, the third portion 512 is made of Ag, and the third portion 512 includes a portion of the surface 210 that does not extend to the MFS 139. In another embodiment, the third portion 512 is made of Au, and the third portion 512 includes the entire surface 210 that extends to the MFS 139. Again the surface 210 forms the angle A with the axis L.

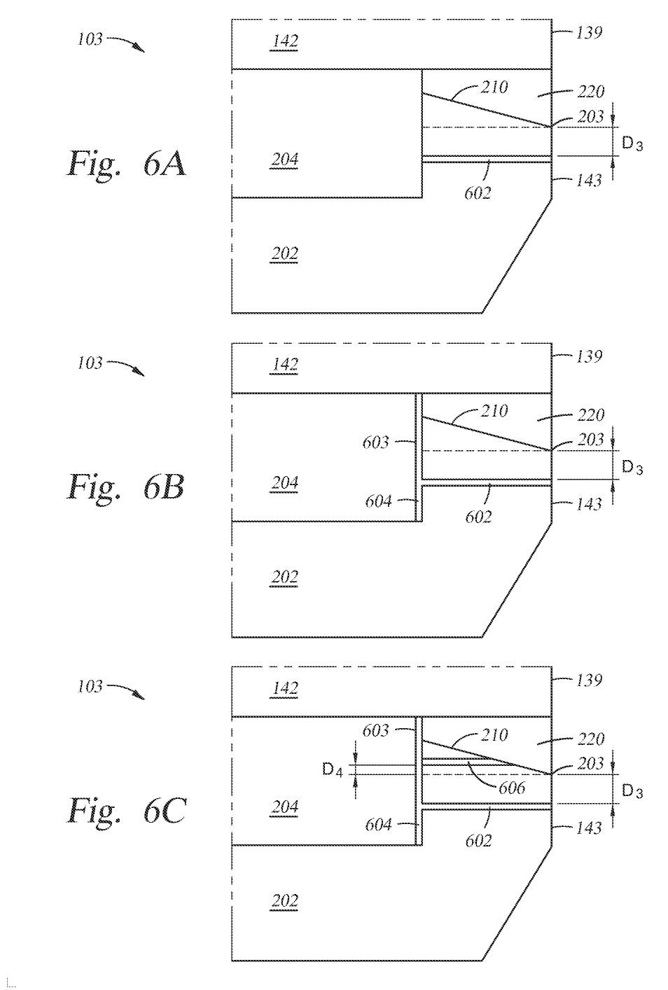

FIGS. 6A-6C are fragmented cross sectional side views of the HAMR write head 103 according to various embodiments. As shown in FIG. 6A, the antenna 202 may include a diffusion barrier layer 602 embedded in the antenna 202. The diffusion barrier layer 602 may be made of a material that has a higher melting point than the material of the antenna 202, such as Co, Ni, Pt, Pd, Ru, Ti, or any suitable material. The diffusion barrier layer 602 may have a thickness ranging from about 1 nm to about 3 nm. In one embodiment, as shown in FIG. 6A, the diffusion barrier layer 602 extends from the MFS 139 to the thermal shunt 204 and is substantially perpendicular to the MFS 139. A distance D₃ may be between the apex 203 and the diffusion barrier layer 602, and the distance D₃ may range from about 5 nm to about 50 nm. During operation, the apex 203 experiences the highest temperature, causing the nearby atoms to migrate to other areas, which leads to deformation of the antenna 202. By inserting the diffusion barrier layer 602 in the antenna 202, atom migration can be prevented.

In some embodiments, an additional diffusion barrier layer 604 may be disposed between the thermal shunt 204 and the antenna 202, as shown in FIG. 6B. The thermal shunt 204 may have a surface 603 facing the MFS 139 and substantially parallel to the MFS 139. The diffusion barrier layer 604 may be disposed on the surface 603 of the thermal shunt 204. The diffusion barrier layer 604 may be made of the same material as the diffusion barrier layer 602 and may have the same thickness. In some embodiments, a third diffusion barrier layer 606 may be embedded in the antenna 202, as shown in FIG. 6C. The third diffusion barrier layer 606 may be substantially parallel to the diffusion barrier layer 602, and may extend from the surface 210 to the diffusion barrier layer 604. The third diffusion barrier layer 606 may be a distance D₄ away from the apex 203, and the distance D₄ may range from about 0 nm to about 30 nm. The third diffusion barrier layer 606 may be made of the same material as the diffusion barrier layer 602 and may have the same thickness.

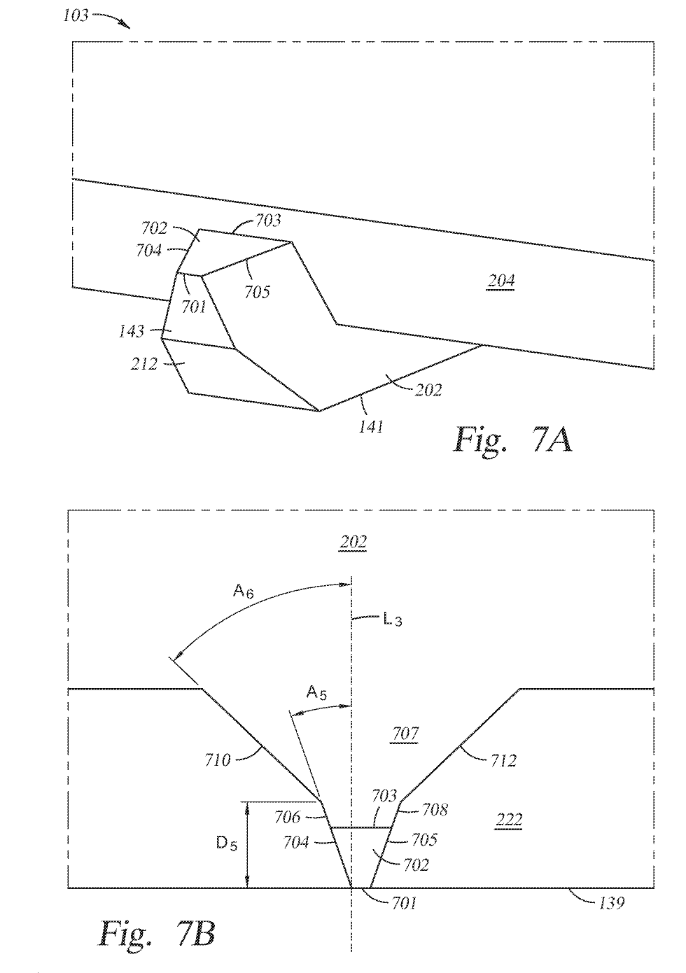

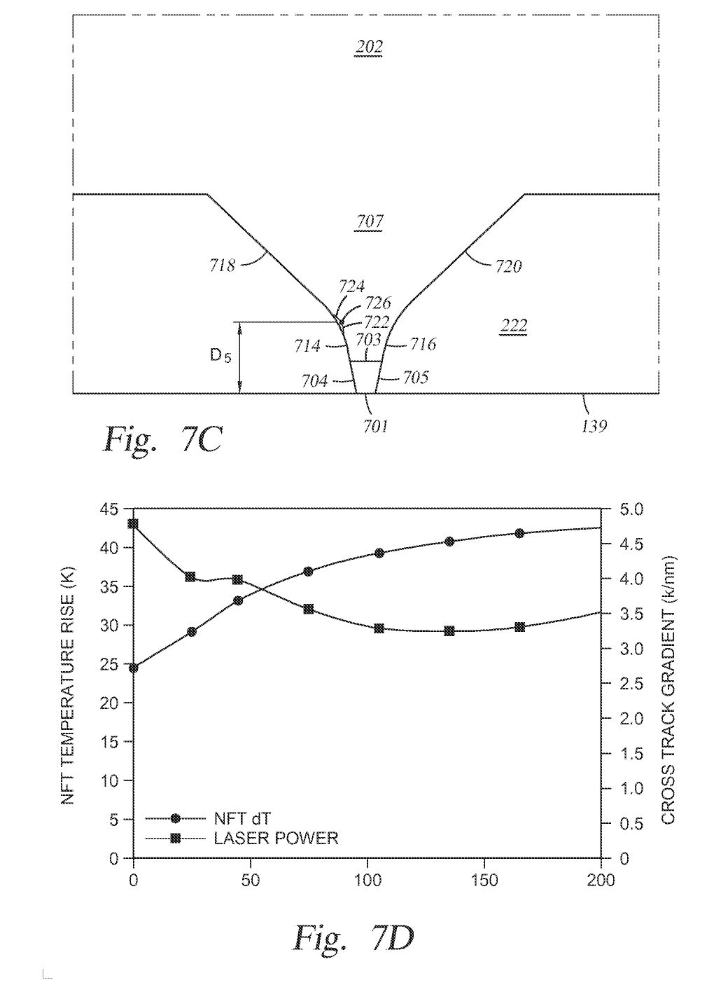

FIGS. 7A-7D illustrate the HAMR write head 103 according to one embodiment described herein. FIG. 7A is a fragmented perspective view of the write head 103 according to one embodiment. As shown in FIG. 7A, the antenna 202 may include the surface 141 facing the waveguide 135 (shown in FIG. 2A), the surface 143 at the MFS 139, the surface 212 connecting the surfaces 141, 143, and a surface 702 facing the main pole 142 (shown in FIG. 2A). Conventionally, the surface facing the main pole 142 may be rectangular. In order to increase the volume of the thermally conductive material of the antenna 202, additional material may be added to the antenna 202. The added material may form the surface 702, which may have a trapezoid shape. The surface 702 may include a first side 701 at the MFS 139, a second side 703 opposite the first side 701, a third side 704 connecting the first side 701 and the second side 703, and a fourth side 705 opposite the third side 704 and also connecting the first side 701 and the second side 703. The first side 701 may be substantially parallel to the second side 703.

FIG. 7B is a top view of the antenna 202 with the thermal shunt 204 removed. As shown in FIG. 7B, the third side 704 and the fourth side 705 of the surface 702 may extend from the MFS 139 toward the thermal shunt 204 (shown in FIG. 7A). The antenna 202 may further include a surface 707 that is in contact with the thermal shunt 204 (shown in FIG. 7A). The surface 707 may include first and second sides 706, 708, each may form an angle A₅ with an axis L₃ that is substantially perpendicular to the MFS 139. The angle A₅ may be greater than 0 degrees and less than about 60 degrees, such as between about 10 degrees and about 30 degrees. In some embodiments, the angle A₅ may be less than about 20 degrees in order to control the reduction of thermal-gradient in the magnetic media 112 to be less than ten percent. Both sides 706, 708 are tapered since the sides 706, 708 are angled (greater than 0 degrees and less than 90 degrees) with respect to the axis L₃ that is substantially perpendicular to the MFS 139. The surface 707 of the antenna 202 may further include side tapers 710, 712, each may form an angle A₆ with the axis L₃. The side taper 710 may be connected to the side 706, and the side taper 712 may be connected to the side 708. The angle A₆ may be greater than the angle A₅, such as between about 30 degrees and about 60 degrees. The sides 706, 708 may extend to a location (i.e., a flare point) that is a distance D₅ away from the MFS 139. In other words, the flare point is the distance D₅ away from the MFS 139.

In some embodiments, sides 706, 708 and side tapers 710, 712 of the surface 707 of the antenna 202 are non-linear. As shown in FIG. 7C, the surface 707 may include non-linear sides 714, 716 and non-linear side tapers 718, 720. A flare point 726 is defined by the intersection of a tangent 722 of the non-linear side 714 and a tangent 724 of the non-linear side taper 718, and the flare point 726 is the distance D₅ away from the MFS 139. FIG. 7D is a chart showing relationships between NFT temperature rise and the location of the flare point and between laser power and the location of the flare point. For an antenna 202 having the angle A₅ (FIG. 7B) to be 10 degrees and the angle A₆ (FIG. 7B) to be 45 degrees, the NFT temperature rise and the laser power are plotted against the distance D₅ in nm (x-axis), as shown in FIG. 7D. For low laser power, the distance D₅ may be between about 70 nm and about 200 nm. For low NFT temperature rise, the distance D₅ may be between about 5 nm and about 70 nm. In one embodiment, the distance D₅ is about 70 nm. When distance D₅ is close to 0, i.e., no flare point, the required laser power is too large and the cross-track thermal gradient is too large.

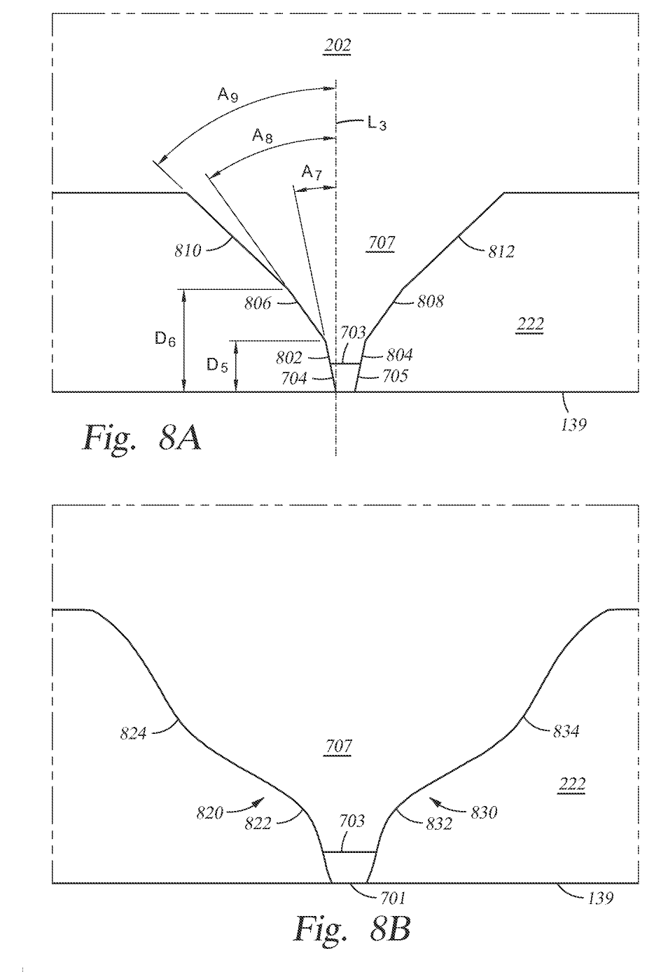

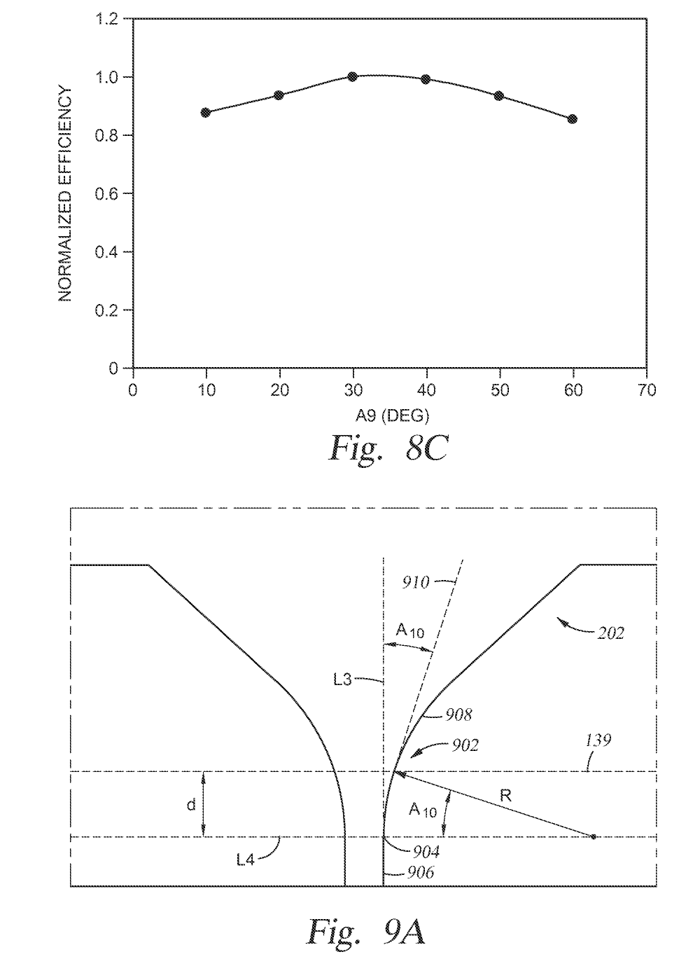

FIG. 8A is a top view of the antenna 202 with the thermal shunt 204 removed. As shown in FIG. 8A, the surface 707 may include first and second sides 802, 804, each may form an angle A₇ with the axis L₃ that is substantially perpendicular to the MFS 139. The angle A₇ may be greater than 0 degrees and less than about 60 degrees, such as about 10 degrees. The sides 802, 804 may extend to a location (i.e., a first flare point) that is the distance D₅ away from the MFS 139. The surface 707 of the antenna 202 may further include a first set of side tapers 806, 808, each side taper 806, 808 may form an angle A₈ with the axis L₃. The side taper 806 may be connected to the side 802, and the side taper 808 may be connected to the side 804. The angle A₈ may be greater than the angle A₇. In one embodiment, the angle A₈ is about 20 degrees. In another embodiment, the angle A₈ is about 60 degrees. The side tapers 806, 808 may extend to a location (i.e., a second flare point) that is the distance D₆ away from the MFS 139. The distance D₆ may be about 80 nm. The surface 707 of the antenna 202 may further include a second set of side tapers 810, 812, each side taper 810, 812 may form an angle A₉ with the axis L₃. The side taper 810 may be connected to the side taper 806, and the side taper 812 may be connected to the side taper 808. The angle A₉ may be greater than the angle A₇. In one embodiment, the angle A₉ is greater than the angle A₈. In another embodiment, the angle A₉ is less than the angle A₈. The angle A₉ may range from about 10 degrees to about 60 degrees. In one embodiment, the angle A₇ is 10 degrees, the angle A₈ is 60 degrees, the distance D₅ is 30 nm, the distance D₆ is 80 nm, and the angle A₉ is plotted against normalized efficiency of the HAMR write head, as shown in FIG. 8C. As shown in FIG. 8C, in order to maximize the normalized efficiency, the angle A₉ is between about 30 and 40 degrees.

In some embodiments, each side 802, 804 and each side taper 806, 808, 810, 812, is non-linear. As shown in FIG. 8B, the surface 707 may include non-linear sides 820, 830. The non-linear side 820 may include one or more concave portions 822 and one or more convex portions 824, and the non-linear side 830 may include one or more concave portions 832 and one or more convex portions 834. Having non-linear sides 820, 830 help reducing the temperature of the antenna 202 during operation without losing thermal-gradient.

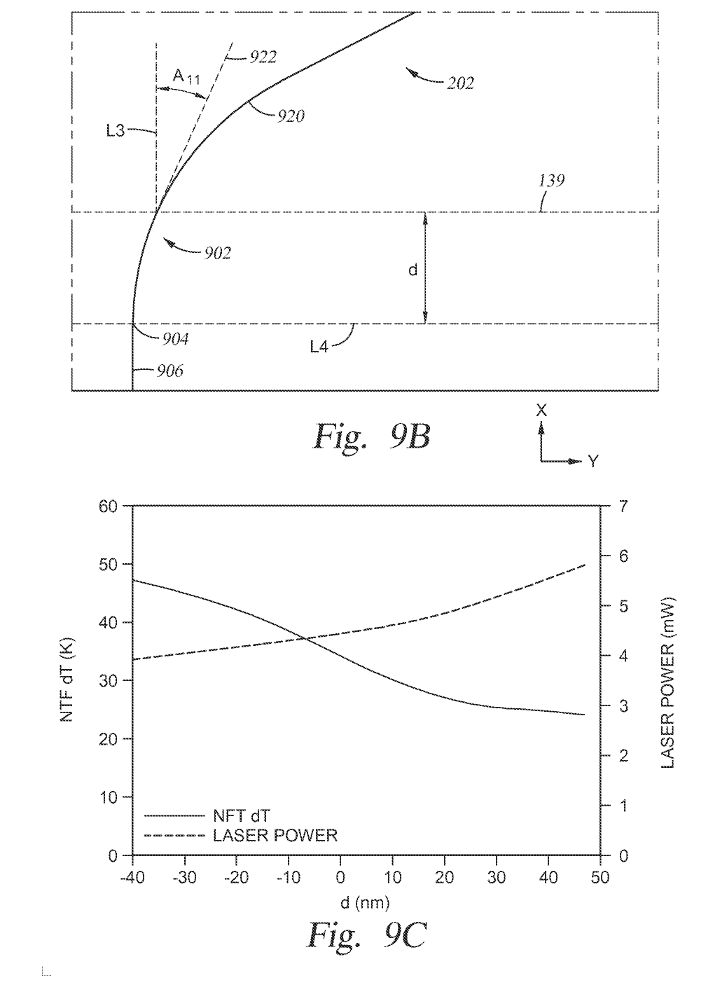

FIGS. 9A-9B illustrate the antenna 202 prior to forming the MFS 139 according to various embodiments described herein. As shown in FIG. 9A, the antenna 202 prior to forming the MFS 139 may include a side 902 having a linear portion 906 and a curved portion 908. The side 902 may include the non-linear side 830 of the surface 707 (FIG. 8B). The linear portion 906 and the curved portion 908 have a connecting point 904. In some embodiments, the curved portion 908 is a portion of a circle having a radius R. An angle A₁₀ may be formed between a tangent 910 at a point on the curved portion 908 or between the radius R and an axis L₄ on the connecting point 904 that is substantially perpendicular to the axis L₃. The axis L₄ may be substantially parallel to the MFS 139. The location of the MFS 139 may be determined by a formula d=R*sin A₁₀, where d is a distance between the axis L₄ and the MFS 139 and the angle A₁₀ is greater than 0 degrees and less than or equal to 20 degrees. In some embodiments, when the required track width is large, the angle A₁₀ is greater than 20 degrees, such as about 30 degrees. The radius R is arbitrary. In one embodiment, the radius R is 200 nm and the distance d is greater than 0 nm and less than or equal to 68 nm. In another embodiment, the radius R is 300 nm and the distance d is greater than 0 and less than or equal to 103 nm. When the distance d is positive, the MFS 139 is located on the curved portion 908. The distance d can also be a negative number, which means the MFS 139 is located on the linear portion 906. FIG. 9C is a chart showing the effect of positions of the MFS 139 on NFT temperature change and on laser power according to various embodiments described herein. As shown in FIG. 9C, when the distance d is negative (MFS 139 located on the linear portion 906), the laser power is low but the NFT temperature is high. When the distance d is positive (MFS 139 located on the curved portion 908), the laser power is high but the NFT temperature is low. When d is too large, the cross-track thermal gradient is reduced. In one embodiment, the distance d is between 0 nm and 35 nm.

In some embodiments, the curved portion 908 is not a portion of a circle. As shown in FIG. 9B, the antenna 202 prior to forming the MFS 139 includes the side 902 having the linear portion 906 and a curved portion 920. The curved portion 920 is not a portion of a circle, and the curved portion 920 may be expressed as y=f(x). An angle A₁₁ may be formed between a tangent 922 at a point on the curved portion 920 and the axis L₃. The distance d may be determined by a formula tan A₁₁=f′(d), where A₁₁ is greater than 0 degrees and less than or equal to 20 degrees. For example, if the curved portion 920 is expressed by y=3*(exp(x/50)−1) (nm), d is greater than 0 nm and less than 90 nm. In some embodiments, when the required track width is large, the angle A₁₁ is greater than 20 degrees, such as about 30 degrees. When the distance d is positive, the MFS 139 is located on the curved portion 920. The distance d can also be a negative number, which means the MFS 139 is located on the linear portion 906.

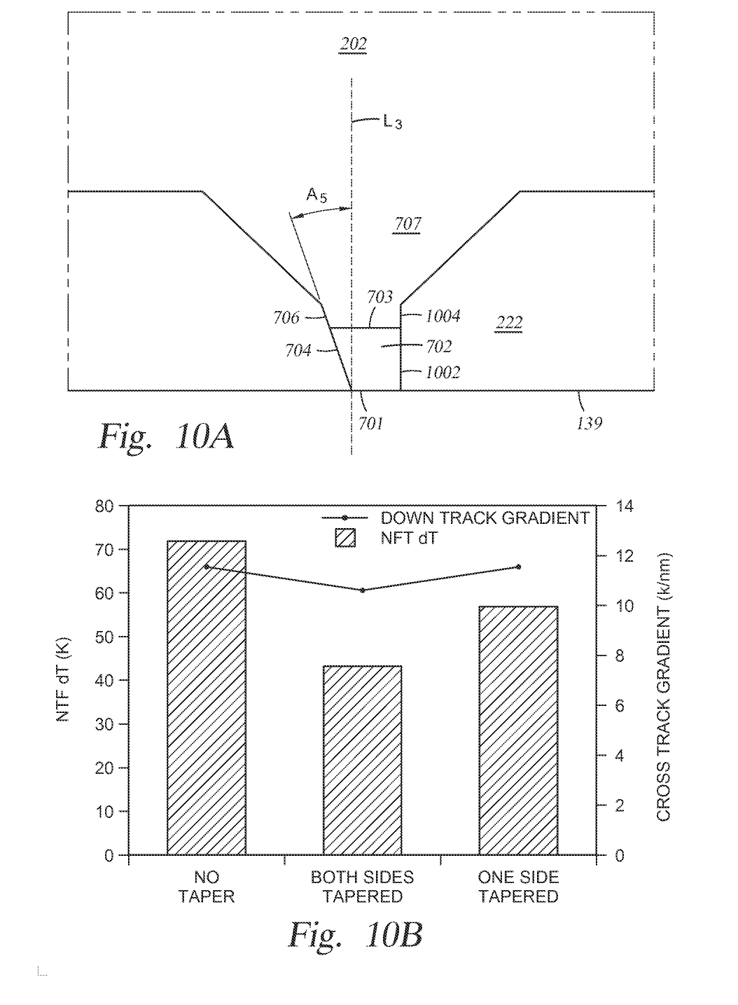

FIG. 10A illustrates the HAMR write head 103 according to various embodiments described herein. As shown in FIG. 10A, the surface 702 of the antenna 202 facing the main pole 142 (FIG. 2A) may include the first side 701, the second side 703, the third side 704, and a fourth side 1002 that is substantially perpendicular to the MFS 139. In other words, one of the two sides that are connecting the side 701 and the side 703 is substantially perpendicular to the MFS 139, while the other side forms an angle with the axis L₃, such as the angle A₅. Similarly, the surface 707 may include the side 706 and a side 1004 that is substantially perpendicular to the MFS 139. FIG. 10B is a chart showing the effect of having both sides tapered and the effect of having one side tapered on the temperature rise of the NFT 140 and the cross-track gradient. As shown in FIG. 10B, when both sides are tapered, the temperature increase of the NFT 140 is the least, but the cross-track gradient is at the lowest. When one side is tapered, as shown in FIG. 10A, the temperature increase of the NFT 140 is greater than the temperature increase of the NFT 140 when both sides are tapered, but the cross-track gradient is higher. The antenna 202 as shown in FIG. 10A may be used in Shingled Magnetic Recording (SMR) since SMR requires a high thermal gradient on one side of an NFT.

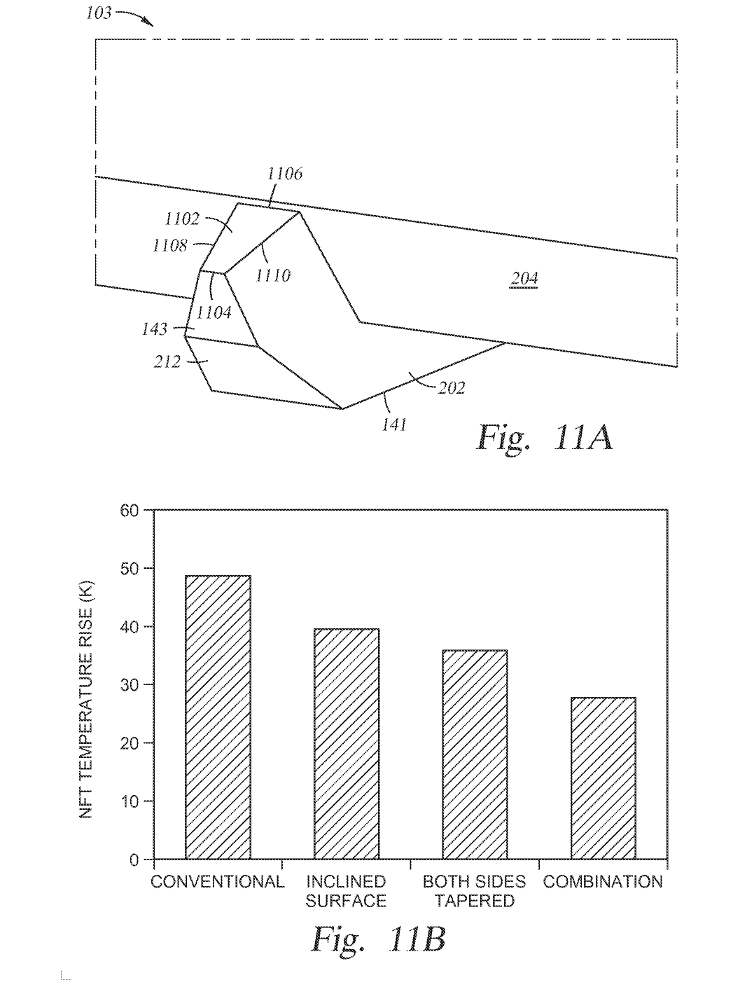

FIG. 11A illustrates the HAMR write head 103 according to various embodiments described herein. The antenna 202 may include both tapered sides and the inclined surface facing the main pole 142. As shown in FIG. 11A, the antenna 202 may include a surface 1102 facing the main pole 142 (FIG. 2A), and the surface 1102 may form the angle A with the axis L. The surface 1102 may be planar or non-planar. The surface 1102 may have a trapezoid shape and may include a first side 1104 at the MFS 139, a second side 1106 opposite the first side 1104, a third side 1108 connecting the first side 1104 and the second side 1106, and a fourth side 1110 opposite the third side 1108 and connecting the first side 1104 and the second side 1106. Again the sides 1108, 1110 may be both tapered or one of the two sides 1108, 1110 is tapered. FIG. 11B is a chart showing the effect of having an inclined surface, having both sides tapered, and the combination of the inclined surface and both sides tapered. As shown in FIG. 11B, the conventional antenna has the highest NFT temperature increase during operation. The antenna with the inclined surface facing the main pole, such as the antenna 202 shown in FIG. 2A, reduces the temperature increase of the NFT during operation by about 10K. The antenna with both sides tapered, such as the antenna 202 shown in FIG. 7A, reduces the temperature increase of the NFT during operation by about 13K. The antenna with the combined inclined surface and tapered sides, such as the antenna 202 shown in FIG. 11A, reduces the temperature increase of the NFT during operation by about 21K.

In summary, embodiments include a HAMR head having a NFT including an antenna having increased volume extending from the MFS in order to reduce the temperature rise of the NFT. The reliability of the HAMR head is improved as a result of the reduced temperature rise of the NFT. The increase volume of the antenna may result in an inclined surface facing the main pole, a trapezoid shaped surface facing the main pole, or both the inclined and trapezoid surface facing the main pole.

While the foregoing is directed to embodiments of the disclosure, other and further embodiments may be devised without departing from the basic scope thereof, and the scope thereof is determined by the claims that follow.

What is claimed is:

1. A heat assisted magnetic recording head, comprising:
a main pole;
a waveguide; and
a near-field transducer disposed between the main pole and the waveguide, wherein the near-field transducer comprises an antenna, wherein the antenna includes a first surface facing the main pole, and wherein the first surface is angled with respect to an axis perpendicular to a media facing surface.

2. The heat assisted magnetic recording head of claim 1, wherein the first surface is non-planar.

3. The heat assisted magnetic recording head of claim 2, wherein the first surface is curved.

4. The heat assisted magnetic recording head of claim 3, wherein the first surface is in contact with the main pole.

5. The heat assisted magnetic recording head of claim 1, wherein antenna includes a second surface facing the waveguide, wherein the second surface is angled with respect to the axis perpendicular to the media facing surface, wherein the waveguide includes a surface facing the second surface of the antenna, and wherein the surface of the waveguide is parallel to the second surface of the antenna.

6. The heat assisted magnetic recording head of claim 1, wherein the antenna includes a first portion and a second portion, wherein the first portion is made of a conductive material that has higher thermal conductivity than a material of the second portion, and wherein the first portion includes at least a portion of the first surface.

7. The heat assisted magnetic recording head of claim 1, further comprising a first diffusion barrier layer embedded in the antenna.

8. The heat assisted magnetic recording head of claim 7, further comprising a thermal shunt coupled to the antenna.

9. The heat assisted magnetic recording head of claim 8, further comprising a second diffusion barrier layer disposed between the thermal shunt and the antenna.

10. The heat assisted magnetic recording head of claim 9, further comprising a third diffusion barrier layer embedded in the antenna.

11. The heat assisted magnetic recording head of claim 1, wherein the first surface has a trapezoid shape.

12. A heat assisted magnetic recording head, comprising:
a main pole;
a waveguide; and
a near-field transducer disposed between the main pole and the waveguide, wherein the near-field transducer comprises an antenna, wherein the antenna includes a first surface facing the main pole, wherein the first surface has a first side at a media facing surface, a second side opposite the first side, a third side connecting the first and second sides, and a fourth side opposite the third side, and wherein at least one of the third and fourth sides is angled with respect to an axis perpendicular to the media facing surface.

13. The heat assisted magnetic recording head of claim 12, further comprising a thermal shunt disposed between the main pole and the antenna, wherein the antenna further comprises a second surface in contact with the thermal shunt, wherein the second surface includes a first side and a second side.

14. The heat assisted magnetic recording head of claim 13, wherein the second surface further comprises a first and second side tapers, wherein the first side and the second side each forms a first angle with the axis, wherein the first and second side tapers each forms a second angle with the axis, and wherein the second angle is greater than the first angle.

15. The heat assisted magnetic recording head of claim 14, wherein the second surface further comprises a third and fourth side tapers, wherein the third and fourth side tapers each forms a third angle with the axis, and wherein the third angle is greater than the first and second angles.

16. The heat assisted magnetic recording head of claim 13, wherein the first side and the second side each includes one or more concave portions and one or more convex portions.

17. The heat assisted magnetic recording head of claim 13, wherein the first side is curved, and wherein the media facing surface is located on the curved first side.

18. The heat assisted magnetic recording head of claim 13, wherein the first side is curved, wherein the curved first side includes a portion of a circle, wherein the media facing surface is located at a distance from a starting point of the curved first side, wherein the distance is determined by a formula R*sin A, where R is a radius of the circle and A is an angle formed between a tangent at a point on the curved first side and an axis that is substantially parallel to the media facing surface.

19. The heat assisted magnetic recording head of claim 13, wherein the first side is curved, and the curved first side is expressed by y=f(x), wherein the media facing surface is located at a distance from a starting point of the curved first side, wherein the distance is determined by a formula tan A=f′(d), where A is an angle formed between a tangent at a point on the curved first side and an axis that is substantially parallel to the media facing surface.

20. A hard disk drive, comprising:
a magnetic media;
a magnetic read head; and
a heat assisted magnetic recording magnetic write head, wherein the heat assisted magnetic recording magnetic write head comprises:
a main pole;
a waveguide; and
a near-field transducer disposed between the main pole and the waveguide, wherein the near-field transducer comprises an antenna, wherein the antenna includes a surface facing the main pole, and wherein the surface is angled with respect to an axis perpendicular to a media facing surface.
